(19) United States
(12) Patent Application Publication
(10) Pub. No.: US 2026/0183770 A1
(43) Pub. Date: Jul. 2, 2026

(54) SCRAP METAL REDUCTION

(71) Applicant: Brian Powell, Iola, WI (US)

(72) Inventor: Brian Powell, Iola, WI (US)

(21) Appl. No.: 19/008,114

(22) Filed: Jan. 2, 2025

(51) Int. Cl. B02C 4/08; B02C 23/08; B03C 1/023

(52) U.S. Cl. CPC B02C 4/08; B02C 23/08; B03C 1/023

(57) ABSTRACT

A method of reducing input scrap metal into scrap metal segments for shredding scrap metal to a desirable size includes feeding the input scrap metal into a metal shredder and shredding, via a shredding action of the metal shredder, the input scrap metal to form the scrap metal segments. Each scrap metal segment of the scrap metal segments is formed to have a length of between 12.0 inches and 60.0 inches, a width of between 1.0 inches and 18.0 inches, and a thickness of between 0.125 inches and 6.0 inches.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) Incorporation-by-reference of Material Submitted on a COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

(g) BACKGROUND OF THE INVENTION

### (1) Field of the Invention

The disclosure relates to scrap metal reduction methods and more particularly pertains to a new scrap metal reduction method for shredding scrap metal to a desirable size and removing contaminants from the scrap metal.

### (2) Description of Related Art including information disclosed under 37 CFR 1.97 and 1.98

Various scrap metal reduction apparatuses, systems, and methods are provided by the prior art, including myriad metal shredders. However, the prior art fails to describe a method of scrap metal reduction which forms strips of scrap metal having desirable dimensions for recycling in a foundry.

### (h) BRIEF SUMMARY OF THE INVENTION

An embodiment of the disclosure meets the needs presented above by generally comprising feeding the input scrap metal into a metal shredder and shredding, via a shredding action of the metal shredder, the input scrap metal to form the scrap metal segments. Each scrap metal segment of the scrap metal segments is formed to have a length of between 12.0 inches and 60.0 inches, a width of between 1.0 inches and 18.0 inches, and a thickness of between 0.125 inches and 6.0 inches.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an exemplary metal shredder which may be used in a method of reducing input scrap metal into scrap metal segments according to an embodiment of the disclosure.

FIG. 2 is a perspective view of a scrap metal segment which may be produced via an embodiment of the disclosure.

FIG. 3 is a flow diagram of an embodiment of the disclosure.

### (J) DETAILED DESCRIPTION OF THE INVENTION

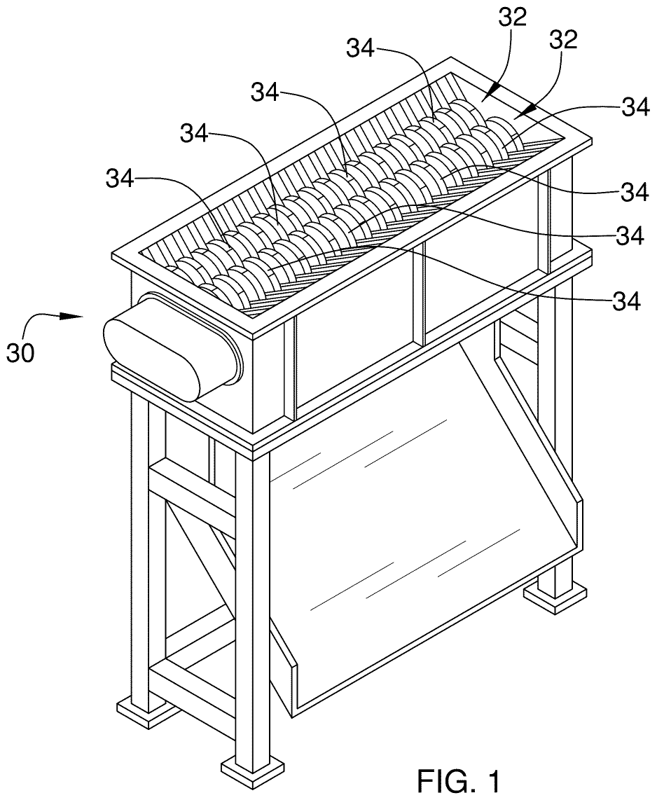

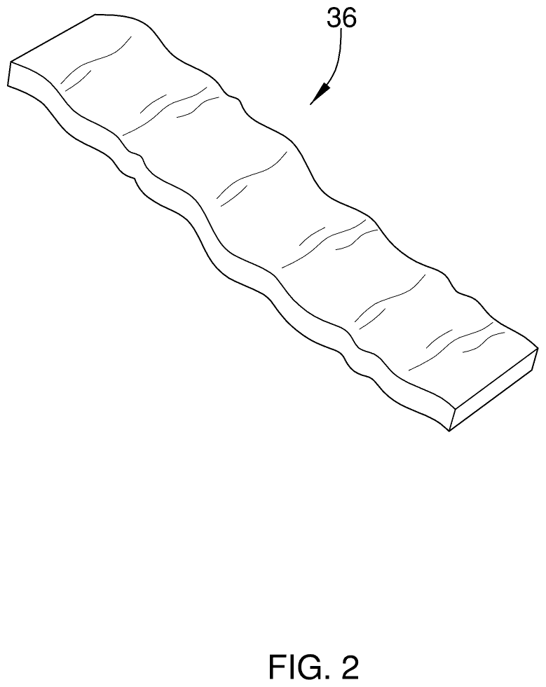

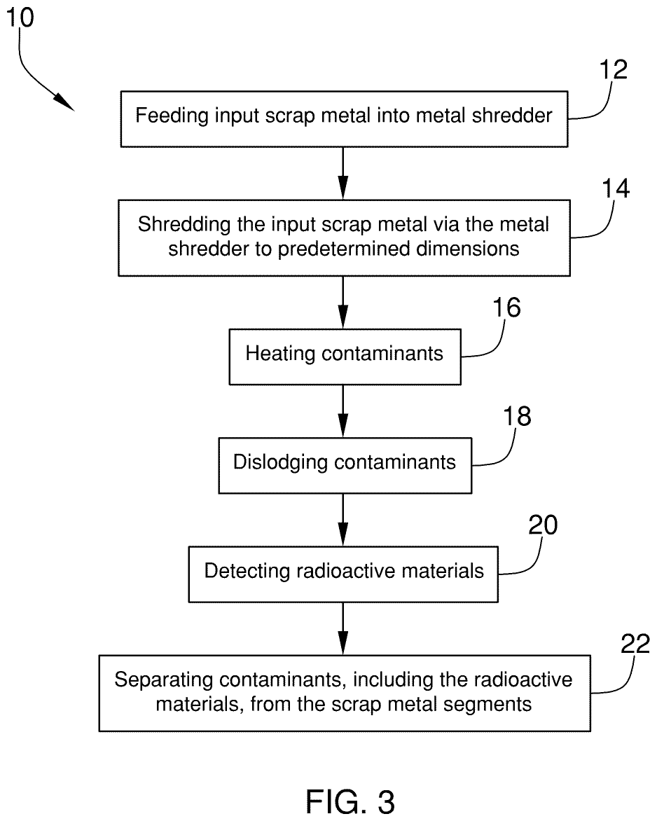

With reference now to the drawings, and in particular to FIGS. 1 through 3 thereof, a new scrap metal reduction method embodying the principles and concepts of an embodiment of the disclosure and generally designated by the reference numeral 10 will be described.

As best illustrated in FIGS. 1 through 3, the method of reducing input scrap metal into scrap metal segments 10 generally comprises feeding 12 the input scrap metal into a metal shredder and shredding 14 the input scrap metal to form the scrap metal segments 36 in a shredding action of the metal shredder. The metal shredder may operate in the shredding action, for example, by rotating a rotary cutter with cutting teeth that are spaced from each other in an axial direction with respect to the rotary cutter. As the input scrap metal is fed into the rotary cutter while rotating the rotary cutter, the cutting teeth remove material along parallel lines such that the resulting scrap metal segments 36 have a first linear dimension defined by the distance between the cutting teeth. Additional cutting blades which extend axially between the cutting teeth of the rotary cutter may be provided such that, as the input scrap metal is fed into the metal shredder while rotating the rotary cutter, the cutting blades shear the input scrap metal to define a second linear dimension of the resulting scrap metal segments 36 which is perpendicular to the first linear dimension. Similarly, in some embodiments, the cutting teeth may have axially extending cutting edges which define the second linear dimension.

The first linear dimension and the second linear dimension may vary depending on the spacing of the cutting teeth in the axial direction of the rotary cutter, the spacing of the cutting blades radially around the rotary cutter, and the feed rate of the input scrap metal into the metal shredder. For example, the first linear dimension of each resulting scrap metal segment may be a length dimension, and the second linear dimension of each resulting scrap metal segment may be a width dimension. Conversely, the first linear dimension may be a width dimension, and the second linear dimension may be a length dimension.

An exemplary metal shredder 30 is shown in FIG. 1 and includes a pair of rotary cutters 32, each with a plurality of cutting teeth 34 that are spaced apart from each other in the axial directions of their respective rotary cutters 32. A metal shredder with a single rotary cutter or other cutting implements may also be used. A hopper, a chute, or the like may be used with any metal shredder to direct the input scrap metal into the metal shredder and to contain the input scrap metal in an area adjacent to the cutting implements of the metal shredder until the input scrap metal has been moved passed or through the cutting implements.

Shredding 14 the input scrap metal includes forming the scrap metal segments 36 to each have a length of between 12.0 inches and 60.0 inches, a width of 1.0 inches and 18.0 inches, and a thickness of between 0.125 inches and 6.0 inches. For the purposes of this disclosure, the length, width, and thickness dimensions of the scrap metal segments 36 are defined as being perpendicular to each other. These dimensions may be dependent at least in part on the dimensions of the input scrap metal. For example, the input scrap metal may be selected to have thicknesses already found within the range of 0.125 inches and 60.0 inches, and the metal shredder used. In other embodiments, additional material removal processes may be used to achieve the dimensions disclosed. Ancillary scrap metal pieces may also be formed which do not have the length, the width, and the thickness described above.

The size dimensions are selected to be beneficial for using the scrap metal segments 36 in a cupola furnace of a foundry or another such furnace which relies on combusting fuel to melt the scrap metal segments 36. Smaller segments than those described, which are typically formed in other scrap metal shredding processes known to the art, are more likely to pack together and constrict airflow, which results in poor combustion and less heat for melting scrap metal. The larger segments may more easily be arranged to allow for better airflow and better combustion, resulting in higher heat for the fuel used.

The input scrap metal is likely to have a number of contaminants which would result in poorer quality recycled metal material if not removed prior to melting in a foundry. The contaminants may include, for example, dirt, oils, coatings, radioactive materials, plastics, and the like. Often, the desired metal for recycling is iron. Thus, contaminants may further include nonferrous metals such as aluminum, copper, and zinc. The method 10 further includes steps for identifying and removing at least some of such contaminants such that scrap metal segments 36 having a cubic foot density of between 30.0 pounds and 500.0 pounds are produced.

The shredding action of the metal shredder heats 16 the input scrap metal and the contaminants due to various shearing, abrading, impacting, and similar mechanical actions of the cutting implement and other components of the metal shredder. The heat facilitates removal of at least some of the contaminants, such as oils, coatings, and the like, by improving flowability of liquid substances, or even melting some substances of the contaminants. Such liquid or liquified substances may flow off of the scrap metal segments 36 formed during the shredding action and through gratings or similar outlets. The shredding action also dislodges 18 at least some of the contaminants such as dirt or other contaminants which adhere to exterior surfaces of the input scrap metal. In some embodiments, the heating 16 and dislodging 18 steps also may be performed via other mechanisms such as a dedicated heater and a vibration motor respectively.

Radioactive materials are detected 20 through conventional means such as by an instrument designed to detect or measure ionizing radiation (e.g., a Geiger counter). Radioactive materials may be removed 22 by hand or through an automated sorting/removal process. Contaminants besides the radioactive materials may also be removed manually or through an automated sorting/removal process. An eddy current separator may also be used to induce eddy currents in nonferrous conductive contaminants such as aluminum, copper, and zinc, which thereby causes magnetic fields which repel the nonferrous conductive contaminants away from the scrap metal segments 36. Magnetic sorting may be performed via other means than an eddy current separator, such as using magnets to attract the ferromagnetic scrap metal segments 36 toward the magnets, leaving nonferromagnetic contaminants behind.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of reducing input scrap metal into scrap metal segments, the method comprising:
feeding the input scrap metal into a metal shredder; and
shredding, via a shredding action of the metal shredder, the input scrap metal to form the scrap metal segments, whereby each scrap metal segment of the scrap metal segments is formed to have a length of between 12.0 inches and 60.0 inches, whereby each scrap metal segment of the scrap metal segments is formed to have a width of between 1.0 inches and 18.0 inches, whereby each scrap metal segment of the scrap metal segments is formed to have a thickness of between 0.125 inches and 6.0 inches.

2. The method of claim 1, further comprising heating contaminants positioned among the input scrap metal to facilitate removal of the contaminants from the scrap metal segments.

3. The method of claim 2, wherein the step of heating the contaminants is performed via the shredding action of the metal shredder.

4. The method of claim 1, further comprising dislodging from the scrap metal segments contaminants positioned among the scrap metal segments.

5. The method of claim 4, wherein the step of dislodging the contaminants from the scrap metal segments is performed via the shredding action of the metal shredder.

6. The method of claim 1, further comprising:
detecting radioactive materials of the contaminants among the scrap metal segments; and
removing from the scrap metal segments the radioactive materials detected among the scrap metal segments.

7. The method of claim 1, further comprising separating contaminants from the scrap metal segments.

8. The method of claim 7, wherein the step of separating contaminants from the scrap metal segments includes removing from the scrap metal segments radioactive materials detected among the scrap metal segments.

9. The method of claim 7, wherein the step of separating contaminants from the scrap metal segments includes applying a magnetic field to magnetically separate the contaminants from the scrap metal segments.

10. The method of claim 9, wherein the scrap metal segments are ferromagnetic.

11. The method of claim 9, wherein the step of applying a magnetic field to magnetically separate the contaminants from the scrap metal segments includes applying an eddy current separation process.

12. The method of claim 7, wherein the step of separating contaminants from the scrap metal segments includes manually separating the contaminants from the scrap metal segments.

13. A method of reducing input scrap metal into scrap metal segments, the method comprising:
feeding the input scrap metal into a metal shredder;
shredding, via a shredding action of the metal shredder, the input scrap metal to form the scrap metal segments, whereby each scrap metal segment of the scrap metal segments is formed to have a length of between 12.0 inches and 60.0 inches, whereby each scrap metal segment of the scrap metal segments is formed to have a width of between 1.0 inches and 18.0 inches, whereby each scrap metal segment of the scrap metal segments is formed to have a thickness of between 0.125 inches and 6.0 inches;
heating, via the shredding action of the metal shredder, contaminants positioned among the input scrap metal to facilitate removal of the contaminants from the scrap metal segments;
dislodging, via the shredding action of the metal shredder, the contaminants from the scrap metal segments;
detecting radioactive materials among the scrap metal segments;
separating the contaminants from the scrap metal segments, including:
removing from the scrap metal segments the radioactive materials detected among the scrap metal segments;
applying a magnetic field to magnetically separate the contaminants from the scrap metal segments, wherein the scrap metal segments are ferromagnetic, including applying an eddy current separation process; and
manually separating the contaminants from the scrap metal segments.
